(19) United States
(12) Patent Application Publication
(10) Pub. No.: US 2006/0089477 A1
(43) Pub. Date: Apr. 27, 2006

(54) Ethylene-alpha-olefin copolymer, resin composition containing same and biaxially stretched film thereof

(75) Inventors: Toshitaka Kanai, Ichihara-shi (JP); Shin-ichiro Miyazaki, Ichihara-shi (JP); Hideki Uehara, Marugame-shi (JP); Kunio Sakauchi, Marugame-shi (JP); Toshiro Yamada, Kanazawa-shi (JP)

Correspondence Address: George A. Loud, Esquire;BACON & THOMAS, Fourth Floor, 625 Slaters Lane, Alexandria, VA, 22314-1176, US

(73) Assignee: OKURA INDUSTRIAL CO., LTD., Kagawa-ken (JP)

(21) Appl. No.: 11/202,159

(22) Filed: Aug. 12, 2005

Related U.S. Application Data
(63) Continuation-in-part of application No. 10/771,153, filed on Feb. 4, 2004, now abandoned.

(30) Foreign Application Priority Data
Feb. 7, 2003 (JP) 2003-030308

(51) Int. Cl. C08F 10/00

(52) U.S. Cl. 526/348.1

(57) ABSTRACT

An ethylene-α-olefin copolymer resin having a melt index of 0.5 to 2.0 g/l0 minutes and a density of 0.905 to 0.920 g/cm³ and showing such a temperature raising elution fractionation pattern that the amount of fractions corresponding to a high density polyethylene is 8 to 25% of the total elution and that the amount of fractions eluted up to a temperature of T₄₀° C. is 40% of the total elution and the amount of fractions eluted up to a temperature of T₇₀° C. is 70% of the total elution, wherein the value of 30/(T₇₀−T₄₀) is 2.0 to 3.3% ° C.

### CROSS-REFERENCE TO RELATED APPLICATION

This application is a continuation-in-part of parent U.S. application Ser. No. 10/771,153, filed Feb. 4, 2004. This application also claims, under 35 USC 119, priority of Japanese Patent Application No. 2003-030308, filed Feb. 7, 2003. The disclosures of both the parent U.S. application and Japanese Patent Application No. 2003-030308, inclusive of their specification, claims and drawings, are hereby incorporated by reference herein.

### BACKGROUND OF THE INVENTION

1. Field of the Invention

This invention relates to an ethylene-α-olefin copolymer resin, to a resin composition containing same, to a biaxially stretched film of the ethylene-α-olefin copolymer resin or the resin composition, and to a stretched composite film having a layer of the ethylene-α-olefin copolymer resin or the resin composition. The ethylene-α-olefin copolymer resin and the resin composition give a film which can be easily biaxially stretched in a relatively wide temperature range with a good stretching efficiency. The biaxially stretched film, which is free of wrinkles and has a uniform thickness, is suitably used for shrink packaging articles.

2. Description of Prior Art

A tubular stretching method has previously been adapted to the production of shrinkable packaging films used for heat-shrink packaging various articles such as foods, books and household utensils. Because of good production efficiency and low costs, polypropylene resin films have been used for the tubular stretching method. In recent years, however, low density polyethylene resins films have attracted much attention as a consequence of an increasing demand in the marketplace for packaging films having better shrinkability and material properties.

Low density polyethylene resin films have however a problem in that the temperature range suitable for stretching is smaller than that of polypropylene films. Thus, in order to obtain low density polyethylene resin films suitable for stretching, it is necessary to strictly control the film production conditions. Namely, when the stretching temperature is lower than the desired range, a bubble-shaped tubular film is apt to be punctured during the biaxial stretching of the film. On the other hand, when the stretching temperature is higher than the desired range, the bubble becomes unstable and is greatly influenced by a change in circumstances such as a change in temperature or a slight disturbance of the atmosphere surrounding it. It is, therefore, difficult to obtain biaxially stretched low density polyethylene films having stable material properties and quality.

As heat-shrinkable packaging films, many biaxially stretched films of ethylene-based resin-containing compositions have been proposed. For example, JP-B-H03-018655 proposes a stretched heat-shrinkable film of a resin composition composed of a linear low density polyethylene and a modified polyolefin. JP-B-H05-030855 discloses a stretched heat-shrinkable film of a resin composition composed of 90 to 50% by weight of a first ethylene-α-olefin copolymer having a density of 0.90 to 0.93 g/cm³ and a melt index of 0.2 to 3.0 g/l0 minutes and 10 to 50% by weight of a second ethylene-α-olefin copolymer having a density lower by at least 0.014 g/cm³ than that of the first copolymer and in the range of 0.87 to 0.91 g/cm³ and a melt index of 0.2 to 5.0 g/10 minutes. JP-A-H03-220250 discloses a stretched polyethylene film of a resin composition including a linear low density polyethylene having a density of 0.890 to 0.930 g/cm³ and a specific melt index, an ethylene-α-olefin copolymer having a density of 0.870 to 0.900 g/cm³ and a specific melt index and a melting point, and a surfactant. JP-A-H08-090737 proposes a multi-layered, stretched heat-shrinkable film having opposite surface layers each formed of a resin composition including specific proportions of a high pressure polyethylene having a density of 0.917 to 0.935 g/cm³ and a specific melt index, an ethylene-α-olefin copolymer having a density of 0.870 to 0.910 g/cm³ and a specific melt index and a melting point, and a linear low density polyethylene having a specific melt index and a melting point.

Since, as described above, the stretchability of a polyethylene resin film is inferior as compared with other polymer films such as polypropylene resin films, the above films still have a problem of a narrow temperature range in which stretching can be suitably carried out. It is, thus, difficult to produce stretched films of the above resin composition in a stable manner over a long production time.

To cope with the foregoing problems, JP-A-2001-26684 proposes a polyethylene resin composition including specific proportions of two low density polyethylene resins, particularly, a linear low density polyethylene resin having a density of 0.910 to 0.930 g/cm³ and a linear very low density polyethylene resin having a density of 0.880 to 0.915 g/cm³, and one high density polyethylene resin, particularly a linear high density polyethylene resin having a density of 0.925 to 0.945 g/cm³. While the proposed resin composition can give a biaxially stretched film having a uniform thickness and an improved stretchability, the temperature range in which a film of the resin composition can be suitably stretched is still not fully satisfactory.

### BRIEF SUMMARY OF THE INVENTION

It is, therefore, an object of the present invention to provide a novel ethylene-α-olefin copolymer resin capable of giving a film which permits stretching to be carried out in a wide temperature range in a stable manner.

Another object of the present invention is to provide an ethylene-α-olefin copolymer resin of the above-mentioned type, which can give a biaxially stretched film having excellent material properties such as haze, impact resistance and tear strength.

In accomplishing the above objects, there is provided in accordance with one aspect of the present invention an ethylene-α-olefin copolymer resin having a melt index of 0.5 to 2.0 g/10 minutes and a density of 0.905 to 0.920 g/cm³ and showing such a temperature raising elution fractionation pattern that the amount of fractions corresponding to a high density polyethylene is 8 to 25% of the total elution and that the amount of fractions eluted up to a temperature of T₄₀° C. is 40% of the total elution and the amount of fractions eluted up to a temperature of T₇₀° C. is 70% of the total elution, wherein the value of 30/(T₇₀−T₄₀) is 2.0 to 3.3%/° C.

The melt index is measured in accordance with ASTM D1238 at a temperature of 190° C. and a load of 2.16 kg.

In another aspect, the present invention provides a resin composition comprising the above ethylene-α-olefin copolymer resin, and an ethylene-based resin which differs from the above ethylene-α-olefin copolymer resin.

In a further aspect, the present invention provides a biaxially stretched film of the above ethylene-α-olefin copolymer resin or the above resin composition.

The present invention also provides a composite stretched film comprising two or more laminated resin layers, wherein at least one of said resin layers is a stretched layer of the above ethylene-α-olefin copolymer resin or the above resin composition.

### BRIEF DESCRIPTION OF THE DRAWINGS

Other objects, features and advantages of the present invention will become apparent from the detailed description of the preferred embodiments of the invention which follows, when considered in light of the accompanying drawings, in which:

FIG. 1 is a temperature raising elution fractionation pattern (the fractional concentration as a function of elution temperature) of an ethylene-l-octene copolymer obtained in Example 1; and

FIG. 2 is a temperature raising elution fractionation pattern (the integral ratio of melting component as a function of elution temperature) for the ethylene-l-octene copolymer obtained in Example 1.

### DETAILED DESCRIPTION OF THE PREFERRED EMBODIMENTS OF THE INVENTION

The ethylene-α-olefin copolymer resin according to the present invention may be obtained by copolymerizing ethylene with at least one a-olefin preferably having 3 to 20 carbon atoms in the presence of a catalyst. Preferably, a Ziegler-Natta catalyst system comprising a solid titanium catalytic component including titanium, magnesium and an electron donating material, and an organic aluminum compound is used as the catalyst. Further, so-called single site metallocene catalyst systems such as the monocyclo-pentadienyl transition metal olefin polymerization catalysts may also be preferably used to manufacture the novel copolymer resin.

Examples of the a-olefin include propylene, 1-butene, 3-methyl-l-butene, 4-methyl-l-butene, 1-pentene, 3-methyl-1-pentene, 4-methyl-l-pentene, 3,3-dimethyl-l-pentene, 3,4-dimethyl-l-pentene, 4,4-dimethyl-l-pentene, 1-hexene, 4-methyl-l-hexene, 5-methyl-l-hexene, l-octene, 1-decene, 1-dodecene, 1-tetradecene, 1-hexadecene, l-octadecene and 1-eicocene. Preferably, one or more α-olefins are charged in a reactor together with a solvent and hydrogen and the contents are heated to a predetermined polymerization temperature. Then, ethylene and a Ziegler-Natta catalyst are simultaneously fed to the reactor. The mixture is then reacted at a temperature of 160 to 220° C., preferably 170 to 190° C., for 1 to 60 minutes, preferably 2 to 30 minutes, while maintaining the total pressure in the reactor at 2 to 12 MPa. As the solvent, a hydrocarbon solvent having 5 to 18 carbon atoms may be used. The hydrocarbon solvent may be an aliphatic, alicyclic or aromatic hydrocarbon. Illustrative of suitable solvents are n-hexane, n-pentane, heptane, octane, nonane, decane, tetradecane, cyclohexane, benzene, toluene and xylene.

It is important that the ethylene-α-olefin copolymer resin of the present invention should have a melt index of 0.5 to 2.0 g/10 minutes (measured in accordance with ASTM D1238 at a temperature of 190° C. and a load of 2.16 kg) and a density of 0.905 to 0.920 g/cm³. When the melt index is below 0.5 g/10 minutes, the tension strength of a bubble-shaped tubular film becomes excessively high so that puncture of the bubble is apt to be caused during the tubular stretching. On the other hand, when the melt index exceeds 2.0 g/10 minutes, the bubble becomes unstable and is greatly influenced by a change in circumstances. Thus, in either case, it becomes difficult to continuously perform the stretching in a stable manner. The melt index is preferably 0.7 to 1.6 g/10 minutes. When the density of the copolymer resin is higher than 0.920 g/cm³, it is difficult to stretch the resin film because the crystallinity thereof is high. On the other hand, when the density of the resin is lower than 0.905 g/cm³, the crystallinity thereof is too low to form stable bubbles during stretching. For reasons of excellent stretchability and good balance between the elasticity and shrinkability, the density is preferably 0.910 to 0.918 g/cm³.

In order for the copolymer resin to be stretchable in a wide temperature range, it is important that the ethylene-α-olefin copolymer resin should show such a temperature raising elution fractionation (TREF) pattern that the amount of fractions corresponding to a high density polyethylene (HDPE) is 8 to 25% of the total elution and that the amount of fractions eluted up to a temperature of T₄₀° C. is 40% of the total elution and the amount of fractions eluted up to a temperature of T₇₀° C. is 70% of the total elution, wherein the value of 30/(T₇₀−T₄₀) is 2.0 to 3.3%/° C.

When the value of 30/(T₇₀−T₄₀) exceeds 3.3%/° C., the temperature range suitable for stretching is so narrow that a strict process control is required to prevent puncture and swing of the bubble during tubular stretching. When the value of 30/(T₇₀−T₄₀) is smaller than 2.0%/° C., the contents of low and high melting temperature components becomes high. As a consequence, during stretching the high melting temperature components (which correspond to HDPE components) remain unmelted and crystalline while the low melting temperature components (which correspond to fractions eluted up to a temperature of 60° C. in TREF) are melted. Therefore, the film cannot be uniformly stretched. The value of 30/(T₇₀−T₄₀) is preferably 2.5 to 3.2%/° C.

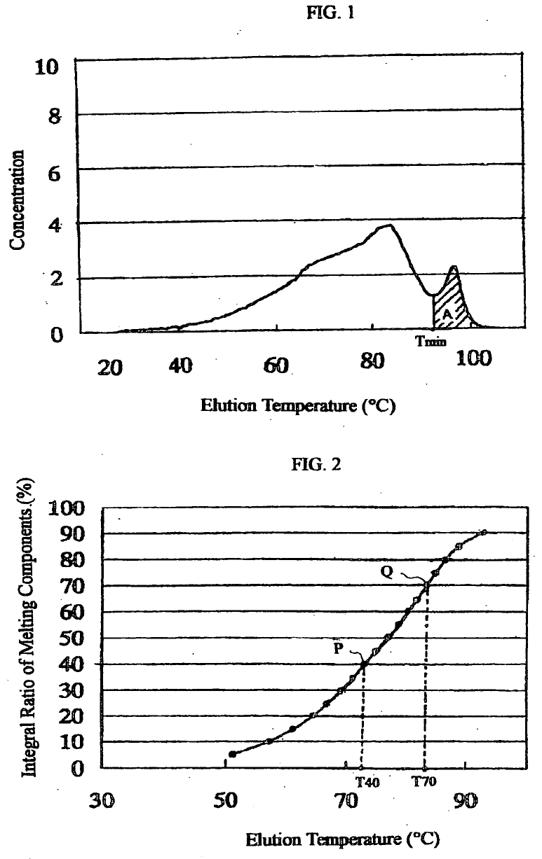

FIG. 1 is a TREF curve showing the concentration of components eluting at respective elution temperatures. FIG. 2 is an integral ratio of melting components (cumulative fraction percentage) obtained from the curve shown in FIG. 1. As shown in FIG. 2, at temperatures of T₄₀° C. (=73.2° C.) and T₇₀° C. (=83.2° C.), the cumulative amounts of the eluted fractions are 40% and 70%, respectively, of the total elution. The value of 30/(T₇₀-T₄₀) represents the inclination of a line connecting the points P and Q on the cumulative percentage vs. temperature curve and is 3%/° C. (=30/(83.2−73.2) %/° C.) in the illustrated case.

When the mount of fractions corresponding to HDPE is greater than 25% of the total elution, it is difficult to stretch the resin film because the crystallinity thereof is high. On the other hand, when the mount of fractions corresponding to HDPE is lower than 8% of the total elution, the crystallinity thereof is too low to form stable bubbles during stretching. Further, the rigidity of the film is not satisfactory. Thus, the ethylene-α-olefin copolymer resin may be regarded as being a composition comprising the HDPE fractions and non-HDPE fractions.

As used herein, the term “amount of fractions corresponding to HDPE” is intended to refer to the amount of high melting temperature fractions determined from the TREF pattern of the ethylene-α-olefin copolymer resin as follows:

(A) When the TREF pattern has only one minimal value of the concentration as shown in FIG. 1 (the minimal value is present in the bottom of the valley between the two peaks) and when the temperature (Tₘᵢₙ) providing the minimal value is 85° C. or more, then the amount of fractions corresponding to HDPE is the amount of fractions eluting at temperatures of Tₘᵢₙ or higher. In the specific embodiment shown in FIG. 1, Tₘᵢₙ is 91.8° C. Thus, the amount of fractions corresponding to HDPE is the area (integral) of the TREF pattern in the temperature range of 91.8° C. or higher, i.e. the shaded area “A” shown in FIG. 1.

(B) When the TREF pattern has two or more minimal values of the concentration (namely, when three or more peaks are present), the higher temperature side minimal value is adopted. When the temperature (Tₘᵢₙ) providing the higher temperature side minimal value is 85° C. or more, then the amount of fractions corresponding to HDPE is the amount of fractions eluting at temperatures of Tₘᵢₙ or higher.

(C) When the TREF pattern has no minimal value of the concentration (namely when there is only one peak) or when the above temperature Tmin is lower than 85° C., then the amount of fractions corresponding to HDPE is the amount of fractions eluting at temperatures of 91.8° C. or higher.

The present invention also provides a resin composition containing the above ethylene-α-olefin copolymer resin and at least one ethylene-based resin other than the above ethylene-α-olefin copolymer resin. Any ethylene-based resin, such as an ethylene-α-olefin copolymer, may be suitably used in any desired amount for the purpose of the present invention as long as the resulting resin composition has a melt index of 0.5 to 2.0 g/l0 minutes and a density of 0.905 to 0.920 g/cm³ and shows such a temperature raising elution fractionation pattern (TREF pattern) that the amount of fractions corresponding to a high density polyethylene is 8 to 25% of the total elution and that the amount of fractions eluted up to a temperature of T′₄₀° C. is 40% of the total elution and the amount of fractions eluted up to a temperature of T′₇₀° C. is 70% of the total elution, wherein the value of 30/(T′₇₀−T′₄₀) is 2.0 to 3.3%/° C.

In order for a raw material film of the above resin composition to be stretchable in a wide temperature range, the resin composition should meet with the above requirements with respect to the melt index, density and TREF pattern. The term “TREF pattern” of the resin composition as used herein has the same meaning as described above with reference to the above ethylene-α-olefin copolymer resin. Thus, the amount of fractions corresponding to HDPE and the value 30/(T′₇₀−T′₄₀) of the resin composition are determined from the TREF pattern of the resin composition in the same manner as those of the ethylene-a-olefin copolymer resin.

Any known additive conventionally used in heat-shrink packaging films may be incorporated into the resin composition of the present invention. Non-limiting examples of the additive include an anti-oxidant, a neutralizing agent, an anti-slip agent, an anti-blocking agent, an anti-fogging agent, a lubricant, a nucleating agent, a weathering stabilizer, a heat stabilizer, a pigment, a dye, a plasticizer, an anti-aging agent and an anti-static agent. As the anti-oxidant, there may be used a phenol type anti-oxidant, a sulfur-type anti-oxidant and/or phosphite type anti-oxidant. The resin composition may be suitably obtained by mixing the above ethylene-α-olefin copolymer resin and at least one additive in a conventional manner using a suitable mixer such as an extruder or a Bumbury mixer. The resin composition may be in the form of pellets, blocks, films, cylinders, rods or any other desired shape.

The above ethylene-α-olefin copolymer resin or the above resin composition may be extruded into a raw material film and the raw material film biaxially stretched to form a heat-shrinkable film. The extrusion may be suitably carried out by a T-die casting film forming method or an inflation film forming method at a resin temperature of 190 to 270° C. The extruded film is cooled by air or water to form the raw material film which generally has a thickness of 100 to 700 μm, preferably 200 to 500 μm.

The biaxial stretching may be carried out by a tenter method when the raw material film is produced by the T-die casting method. Tubular stretching is adopted when the raw material film is produced by an inflation film forming method. In the case of the tenter method, the biaxial stretching can be carried out simultaneously or in multiple stages where the stretching along the machine direction and stretching along the transverse direction are separately and successively performed.

The stretching ratio in the biaxial stretching is generally 1.5 to 20, preferably 2 to 17, more preferably 3 to 15, in each direction. The temperature and drawing speed may be suitably determined in view of the material properties and melt characteristics of the copolymer resin or resin composition as well as the thickness of the raw material films and stretching ratio. The stretched film may be suitably aged or heat treated, if necessary.

The stretched film according to the present invention may be in the form of a multi-layered film having at least one layer formed of the above ethylene-α-olefin copolymer resin or the above resin composition. Thus, the multi-layered film may have a heterogeneous layer or layers formed of a resin other than the above ethylene-α-olefin copolymer resin or the above resin composition. However, the heterogeneous layer or layers are preferably made of an olefin-based resin. Such an olefin-based resin may be an ethylene-based resin, an α-olefin-based resin or a copolymer thereof. It is preferred that at least one of the two outermost layers of the multi-layered film be formed of the above ethylene-α-olefin copolymer resin or the above resin composition according to the present invention, so that the excellent properties attained by the present invention can be suitably attained in the multi-layered film. The stretched multi-layered film of the present invention may be produced by biaxially stretching a raw material multi-layered film which may be produced by any suitable conventional method.

The biaxially stretched film according to the present invention may be advantageously utilized for heat-shrink packaging various articles such as plastic or paper containers containing foods (e.g. cup noodles), plastic or paper containers containing various drinks, fruit processed foods or dairy products, cans containing juice or alcohol, books, CD cases, household utensils and stationery products.

The following examples will further illustrate the present invention.

### EXAMPLE 1

### Preparation of Ethylene-1-OcteneCopolymer Resin

Argon gas was fed to a 1 L polymerization reactor equipped with a stirrer for sufficiently purging air therefrom. Then, 400 ml (milliliter) of dry n-hexane, 65 ml of l-octene, 0.115 mmol of isopropyl chloride and 0.008 MPa (gauge pressure) of hydrogen were charged in the reactor and heated to 171° C. Separately, to a catalyst preparation vessel containing 35 ml of n-hexane, 0.28 mmol (in terms of A1) of ethyl aluminium sesquichloride, 0.112 mmol of methanol, 0.07 mmol of n-butyl magnesium and, finally, 0.015 mmol of tetrabutoxytitanium were successively added and mixed with each other to obtain a mixture. The resulting mixture was then introduced into the above polymerization reactor together with an ethylene gas. The polymerization was performed at 171° C. for 5 minutes while maintaining the total pressure in the reactor at 3.1 MPa (gauge pressure), thereby obtaining 70 g of ethylene-1-octene copolymer resin (linear low density polyethylene resin). The copolymer resin was found to have a melt index of 1.2 g/10 minutes and a density of 0.915 g/cm³ and to show such a TREF pattern that the amount of fractions corresponding to HDPE was 9.5% of the total elution and that the value of 30/(T₇₀−T₄₀) was 3.0%/° C. The melt index, density and TREF analysis were carried out in the manner given below.

(a) Melt Index (MI):

The melt index is measured in accordance with ASTM D1238 at a temperature of 190° C. and a load of 2-16 kg.

(b) Density:

The density is measured using a density measuring device (ACUPIC 1330 manufactured by Micrometrix Inc.) whose measurement accuracy is comparable to the conventional density gradient tube method.

(c) TREF Analysis

The TREF pattern was measured using a measuring device (manufactured by Idemitsu Petrochemical Co., Ltd.) under the following conditions:

Solvent: o-dichlorobenzene

Flow rate: 150 ml/hr

Temperature raising rate: 4° C./hr

Detector: IR detector

Measuring wavelength: 2928 cm^{-l} (CH₂ stretching vibration)

Column: diameter 30 mm, length 300 mm

Filler: chromosolve P

Sample concentration: 1 g/ 120 ml

Amount of injection: 100 ml

The TREF pattern of the above ethylene-1-octene copolymer resin is shown in FIG. 1. FIG. 2 shows cumulative fraction percentage as a function of temperature obtained from the results of FIG. 1. As described previously, the value of 30/(T₇₀−T₄₀) is 3%/° C. (=30/(83.2−73.2) %/° C.). The amount of fractions corresponding to HDPE is the shaded area “A” shown in FIG. 1.

Preparation of Biaxially Stretched Film:

The ethylene-1-octene copolymer resin obtained above was charged in an extruding device having an extruder (diameter: 65 mm), a spiral die (diameter: 180 mm) and a cooler ring (cooling medium: water) and extruded at an extruding rate of 47 kg/hr and a die exit temperature of 170° C. to form a tubular raw material film having a thickness of 375 μm and a width of 235 mm. The raw material film was then passed to a tubular stretching machine having a cylindrical IR heating oven and a take-up device, where the film was biaxially stretched at a temperature of 107° C. with a stretching ratio in the machine direction (MD) of 5 and a stretching ratio in the transverse direction (TD) of 5, thereby obtaining a biaxially stretched film having a thickness of 15 μm and a width of 1180 mm. The stretched film was measured for tearing load and haze in the following manner.

(d) Tearing Load:

The tearing load is measured in accordance with ASTM D1922.

(e) Haze:

The haze was measured in accordance with ASTM D1003.

Further, the above raw material film was tested for stretchable temperature range as follows:

(f) Stretchable Temperature Range:

The raw material film is biaxially stretched using a tenter with a stretching ratio of 5.0 in each of the machine and transverse directions to obtain a biaxially stretched film having a thickness of 15 μm at various stretching temperatures increasing from 96° C. to 126° C. at an interval of 2° C. (i.e. 96° C., 98° C., 100, 102° C. . . . ). After the stretching at each temperature, the film is checked as to whether or not the film is suitably biaxially stretched. When stretching is able to be carried out, the haze thereof is measured. The stretching temperature STₘᵢₙ below which the film is torn during stretching but at and above which the film is not torn during stretching is determined. Also determined is the stretching temperature STₘₐₓ above which the film is melted during stretching but at and below which the film is not melted during stretching. The stretchable temperature range Tₛₜᵣ [° C.] of the film is calculated according to the following equation:
Tₛₜᵣ=(STₘₐₓ+1)−(STₘᵢₙ−1).

Further, the stretching temperature ST′ₘₐₓ above which the haze of the stretched film is higher than 1.7 but at and below which the haze is 1.7 or less is determined. Also determined is the temperature ST′ₘᵢₙ below which the haze of the stretched film is higher than 1.7 but at and above 5 which the haze is 1.7 or less. The stretchable temperature range T′ₛₜᵣ [° C.] with satisfactory haze of the film is calculated according to the following equation:
T′ₛₜᵣ=(ST′ₘₐₓ+1)−(ST′ₘᵢₙ−1).
The results are summarized in Table 1.

### EXAMPLE 2

Example 1 was repeated in the same manner as described except that the amount of N-hexane was changed from 400 ml to 380 ml, the amount of l-octene was changed from 65 ml to 85 ml and the amount of hydrogen was changed from 0.008 MPa to 0.004 MPa, thereby obtaining 75 g of ethylene-1-octene copolymer resin. The copolymer resin was found to have a melt index of 1.2 g/l0 minutes and a density of 0.914 g/cm³ and to show such a TREF pattern that the amount of fractions corresponding to HDPE was 14.3% of the total elution and that the value of 30/(T₇₀−T₄₀) was 2.9%/° C. Using the copolymer resin thus obtained, a biaxially stretched film was prepared in the same manner as described in Example 1. The material properties of the stretched film are shown in Table 1.

### EXAMPLE 3

The following three linear low density polyethylene resins LLDPE-A (70% by weight), LLDPE-B (15% by weight) and LLDPE-C (15% by weight) were blended to obtain a mixed resin.

LLDPE-A: has a melt index of 1.1 g/10 minutes and a density of 0.915 g/cm³ and shows such a TREF pattern that the amount of fractions corresponding to HDPE is 23% of the total elution and that the value of 30/(T⁷⁰−T⁴⁰) is 3.2%/° C.;

LLDPE-B: has a melt index of 1.0 g/l0 minutes and a density of 0.902 g/cm³; and

LLDPE-C: has a melt index of 2.5 g/10 minutes and a density of 0.935 g/cm³.

The mixed resin was found to have a melt index of 1.5 g/l0 minutes and a density of 0.915 g/cm³ and to show such a TREF pattern that the amount of fractions corresponding to HDPE was 25.0% of the total elution and that the value of 30/(T′₇₀−T′₄₀) was 2.5%/° C.

The mixed resin was formed into a film and the film was stretched in the same manner as described in Example 1 except that a stretching temperature of 109° C. was used. The material properties of the stretched film are shown in Table 1.

### EXAMPLE 4

A three-layered laminate film having a width of 235 mm was prepared by coextrusion. Each of the two outer layers had a thickness of 75 μm and was formed of the ethylene-l-octene copolymer resin obtained in Example 1, while the core layer interposed between the two outer layers was formed of a mixed resin containing 30% by weight of LLDPE-D having a melt index of 1.0 g/l0 minutes and a density of 0.920 g/cm³ and showing such a TREF pattern that the value of 30/(T₇₀−T₄₀) was 3.5%/° C., 40% by weight of LLDPE-E having a melt index of 1.0 g/10 minutes and a density of 0.902 g/cm³ and 30% by weight of LLDPE-F having a melt index of 2.5 g/l0 minutes and a density of 0.935 g/cm³ and had a thickness of 225 μm. The raw material laminate film was then stretched in the same manner as described in Example 1.

### COMPARATIVE EXAMPLE 1

Example 1 was repeated in the same manner as described except that the amount of N-hexane was changed from 400 ml to 395 ml, the amount of l-octene was changed from 65 ml to 70 ml and the amount of hydrogen was changed from 0.008 MPa to 0.005 MPa and that no methanol was added, thereby obtaining 68 g of ethylene-l-octene copolymer resin. The copolymer resin was found to have a melt index of 1.2 g/10 minutes and a density of 0.914 g/cm³ and to show such a TREF pattern that the amount of fractions corresponding to HDPE was 12.7% of the total elution and that the value of 30/(T₇₀−T₄₀) was 3.5%/C. Using the copolymer resin thus obtained, a biaxially stretched film was prepared in the same manner as described in Example 1 except that a stretching temperature of 108° C. was used. The material properties of the stretched film are shown in Table 1.

### COMPARATIVE EXAMPLE 2

Example 1 was repeated in the same manner as 20 described except that the amount of N-hexane was changed from 400 ml to 440 ml, the amount of l-octene was changed from 65 ml to 25 ml and the amount of hydrogen was changed from 0.008 MPa to 0.016 MPa and that no methanol was added, thereby obtaining 65 g of ethylene-l-octene copolymer resin. The copolymer resin was found to have a melt index of 1.2 g/10 minutes and a density of 0.925 g/cm³ and to show such a TREF pattern that the amount of fractions corresponding to HDPE was 29.1% of the total elution and that the value of 30/(T₇₀−T₄₀) was 3.7%/° C. Using the copolymer resin thus obtained, a biaxially stretched film was prepared in the same manner as described in Example 1 except that a stretching temperature of 116° C. was used. The material properties of the stretched film are shown in Table 1.

### COMPARATIVE EXAMPLE 3

The following three linear low density polyethylene resins LLDPE-G (40% by weight), LLDPE-H (30% by weight) and LLDPE-l (30% by weight) were blended to obtain a mixed resin.

LLDPE-G: has a melt index of 1.0 g/10 minutes and a density of 0.920 g/cm³ and shows such a TREF pattern that the amount of fractions corresponding to HDPE is 23% of the total elution and that the value of 30/(T₇₀−T₄₀) is 3.2%/° C.;

LLDPE-H: has a melt index of 1.0 g/10 minutes and a density of 0.898 g/cm³; and

LLDPE-l: has a melt index of 2.5 g/10 minutes and a density of 0.935 g/cm³.

The mixed resin was found to have a melt index of 1.4 g/10 minutes and a density of 0.915 g/cm³ and to show such a TREF pattern that the amount of fractions corresponding to HDPE was 32.0% of the total elution and that the value of 30/(T′₇₀−T′₄₀) was 1.8%/° C.

The mixed resin was formed into a film and the film was stretched in the same manner as described in Example 1 except that a stretching temperature of 114° C. was used. The material properties of the stretched film are shown in Table 1.

TABLE 1

| | | Example | | | Comparative Example | | |
|---|---|---|---|---|---|---|---|
| | | 1 | 2 | 3 | 1 | 2 | 3 |
| Density (g/cm³) | | 0.915 | 0.914 | 0.915 | 0.914 | 0.925 | 0.915 |
| MI (g/10 min) | | 1.2 | 1.2 | 1.5 | 1.2 | 1.2 | 1.4 |
| 30/(T₇₀-T₄₀) | | 3.0 | 2.9 | | 3.5 | 3.7 | |
| (%/° C.) | | | | | | | |
| 30/(T′₇₀-T′₄₀) | | | | 2.5 | | | 1.8 |
| (%/° C.) | | | | | | | |
| HDPE amount (%) | | 9.5 | 14.3 | 25.0 | 12.7 | 29.1 | 32.0 |
| Stretching | MD | 5.0 | 5.0 | 5.0 | 5.0 | 5.0 | 5.0 |
| ratio | TD | 5.0 | 5.0 | 5.0 | 5.0 | 5.0 | 5.0 |
| Stretching | | 107 | 107 | 109 | 108 | 116 | 114 |
| temperature (° C.) | | | | | | | |
| Tearing | MD | 0.21 | 0.20 | 0.14 | 0.20 | 0.13 | 0.12 |
| load (N) | TD | 0.18 | 0.17 | 0.12 | 0.18 | 0.10 | 0.10 |

| | | | | | | |
|---|---|---|---|---|---|---|
| Haze (%) | 1.5 | 1.4 | 1.4 | 1.5 | 2.9 | 1.8 |
| Stretchable | 14 | 14 | 14 | 8 | 6 | 10 |
| temperature range | | | | | | |
| Tₛₜᵣ (° C.) | | | | | | |
| Stretchable | 7 | 10 | 10 | 4 | 4 | 4 |
| temperature range | | | | | | |
| T′ₛₜᵣ giving good | | | | | | |
| haze (° C.) | | | | | | |

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

What is claimed is:

1. An ethylene-α-olefin copolymer resin having a melt index of 0.5 to 2.0 g/10 minutes, measured in accordance with ASTM D1238 at a temperature of 190° C. and a load of 2.16 kg, and a density of 0.905 to 5 0.920 g/cm³ and showing such a temperature raising elution fractionation pattern that the amount of fractions corresponding to a high density polyethylene is 8 to 25% of the total elution and that the amount of fractions eluted up to a temperature of T₄₀° C. is 40% of the total elution and the amount of fractions eluted up to a temperature of T₇₀° C. is 70% of the total elution, wherein the value of 30/(T₇₀−T₄₀) is 2.0 to 3.3%/° C.

2. An ethylene-α-olefin copolymer resin as claimed in claim 1, wherein said value of 30/(T₇₀−T₄₀) is 2.5 to 3.3%/° C.

3. A resin composition comprising the ethylene-α-olefin copolymer resin according to claim 1, and an ethylene-based resin different from said ethylene-α-olefin copolymer resin, said composition having a melt index of 0.5 to 2.0 g/10 minutes and a density of 0.905 to 0.920 g/cm³ and showing such a temperature raising elution fractionation pattern that the amount of fractions corresponding to a high density polyethylene is 8 to 25% of the total elution and that the amount of fractions eluted up to a temperature of T′₄₀° C. is 40% of the total elution and the amount of fractions eluted up to a temperature of T′₇₀° C is 70% of the total elution, wherein the value of 30/(T′₇₀-T′₄₀) is 2.0 to 3.3%/° C.

4. A resin composition as claimed in claim 3, wherein said value of 30/(T′₇₀−T′₄₀) is 2.5 to 3.3%/° C.

5. A biaxially stretched film of an ethylene-α-olefin copolymer resin according to claim 1.

6. A biaxially stretched film as claimed in claim 5, wherein the stretched film is obtained by tubular stretching.

7. A biaxially stretched film of a resin composition according to claim 3.

8. A biaxially stretched film as claimed in claim 7, wherein the stretched film is obtained by tubular stretching.

9. A composite stretched film comprising two or more laminated resin layers, wherein at least one of said laminated resin layers is a stretched layer of an ethylene-α-olefin copolymer resin according to claim 1.

10. A composite stretched film comprising two or more laminated resin layers, wherein at least one of said laminated resin layers is a stretched layer of an ethylene-α-olefin copolymer resin composition according to claim 3.

11. A resin composition comprising an ethylene-α-olefin copolymer resin having a melt index of 0.5 to 2.0 g/10 minutes, measured in accordance with ASTM D1238 at a temperature of 190° C. and a load of 2.16 kg, and a density of 0.905 to 5 0.920 g/cm³ and showing such a temperature raising elution fractionation pattern that the amount of fractions corresponding to a high density polyethylene is 8 to 25% of the total elution and that the amount of fractions eluted up to a temperature of T₄₀° C. is 40% of the total elution and the amount of fractions eluted up to a temperature of T₇₀° C. is 70% of the total elution, wherein the value of 30/(T₇₀−T₄₀) is 2.0 to 3.3%/° C.

12. A resin composition as claimed in claim 11, further comprising an ethylene-based resin different from said ethylene-α-olefin copolymer resin.

13. A resin composition as claimed in claim 12, said composition having a melt index of 0.5 to 2.0 g/10 minutes, measured in accordance with ASTM D1238 at a temperature of 190° C. and a load of 2.16 kg, and a density of 0.905 to 0.920 g/cm³ and showing such a temperature raising elution fractionation pattern that the amount of fractions corresponding to a high density polyethylene is 8 to 25% of the total elution and that the amount of fractions eluted up to a temperature of T′₄₀° C. is 40% of the total elution and the amount of fractions eluted up to a temperature of T′₇₀° C. is 70% of the total elution, wherein the value of 30/(T′₇₀−T′₄₀) is 2.0 to 3.3%/° C.
